(19) United States
(12) Patent Application Publication
(10) Pub. No.: US 2026/0180099 A1
(43) Pub. Date: Jun. 25, 2026

(54) SYSTEM AND METHOD FOR HANDLING TRANSPORTATION LOAD

(71) Applicant: Fluence Energy, LLC, Arlington, VA (US)

(72) Inventors: Vishakh Brahmanand DWIVEDI, Falls Church, VA (US); Rachan ANJINAYA, Bangalore, Karnataka (IN); Karthik RAMESH, Coimbatore, Tamilnadu (IN)

(73) Assignee: Fluence Energy, LLC, Arlington, VA (US)

(21) Appl. No.: 18/838,006

(22) PCT Filed: Jul. 3, 2024
(86) PCT No.: PCT/US2024/036665

§ 371 Date: Aug. 13, 2024

Related U.S. Application Data
(60) Provisional application No. 63/530,595, filed on Aug. 3, 2023.

(51) Int. Cl. H01M 50/242; H01M 50/204; H01M 50/244; H01M 50/251

(52) U.S. Cl. CPC H01M 50/242; H01M 50/204; H01M 50/244; H01M 50/251

(57) ABSTRACT

An energy storage node of a system and method for handling transportation force loads includes a plurality of battery racks. Each battery rack includes a plurality of rack slots to support a battery string, at least one pair of back cross bars arranged at a rear of the rack slots to reduce a bowing outward force along a width of the battery racks, at least one pair of side cross bars to reduce a bowing outward force along a depth of the battery racks, a plurality of hollow vertical bars, at least one front connector plate arranged at a front of the battery racks to connect at least two of the hollow vertical bars, and at least one back connector plate arranged at a rear of the battery racks to connect the plurality of battery racks to a rear set of the pair of back cross bars.

### CROSS-REFERENCE TO RELATED APPLICATIONS

This application claims priority to U.S. Provisional Patent Application No. 63/530,595 filed on Aug. 3, 2023, titled “System and Method for Handling Transportation Load,” the entire disclosure of which is incorporated by reference herein.

### TECHNICAL FIELD

The present subject matter relates to examples of a lightweight battery energy storage system (BESS) rack designed to handle transportation force loads when fully populated with battery modules. The transportation loads include static acceleration loads, such as those experienced during sea transport, and random vibration loads, such as those experienced during road transport.

### BACKGROUND

Battery energy storage system (BESS) racks are primarily designed to be able to handle force loads experienced when the racks are already installed in-place. Consequently, the force loads contemplated during design of the racks are focused on unloaded racks experiencing transportation forces upon the rack itself, or force loads for stationary, mounted racks loaded with relatively heavy battery modules. Stationary, loaded racks may even be bolted down into a concrete slab, which creates an incredibly strong counterforce to loads experienced by the rack, such as wind, incidental collisions, or seismic activity. As the collection of battery modules can be magnitudinally larger in mass than the unloaded rack, the forces experienced by an unloaded rack are consequently relatively minor—the vibration experienced by a 200-pound rack causes substantially less stress on that rack than the vibration experienced by a two-ton rack loaded with battery modules.

However, it is logistically inefficient to transport battery modules separately from the battery racks into which the battery modules will ultimately be installed: not only will separate transportation require roughly double the amount of transportation space in, for example, a shipping container, but also the installation site will require additional specialized technicians to prepare the battery installation: instead of simply securing the battery rack to a concrete pad with anchor bolts, specialized personnel will need to additionally install all of the battery modules into the battery rack.

These issues with traditional BESS racks primarily result from BESS racks being adapted for use from other types of industrial storage solutions, rather than BESS racks being purpose-built from the ground up for the particularized purpose of storing battery modules on a battery rack, which is then installed inside a battery rack housing. These non-specialized designs are heavier, resist shear forces poorly, off-gas inefficiently, lack stability when mounted in series, and are very difficult to mount within an enclosed space. Improvements in these aspects would allow for safe transportation of laden battery racks, improving transportation logistics, material usage, and installation safety.

### SUMMARY

Hence, there in a need for systems directed to handling transportation force loads placed upon battery racks laden with battery modules for use in a battery energy storage system. The force load handling technologies disclosed herein are implemented within a battery rack of a battery energy storage system, allowing for the mitigation of forces experienced by the battery rack when transported fully laden with battery modules. The force load handling technologies allow for lighter, more stable battery racks, which are able to further improve stability by being physically connected in series. When the battery racks are placed within a confining enclosure, the force load handling technologies allow for improved off-gassing of the battery modules, and more efficient mounting of those battery racks when initially affixed to the confining enclosure. The combination of these improvements facilitated by the force load handling technologies results in a battery energy storage system that is easier and safer to deploy and provide power flow to an application, customer, or electrical grid.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1A is an isometric view of a modular energy storage system that includes multiple energy storage nodes, a central control system element, and an external grid.

FIG. 1B is an isometric view of a single energy storage node, multiple optional energy storage nodes, and an external grid.

FIG. 2A is a front view of two battery racks physically connected in physical series, each battery rack including eight battery modules connected in electrical series.

FIG. 2B is a detail view of the front connection between the two battery racks of FIG. 2A.

FIG. 2C is a detail isometric view of the connection depicted in FIG. 2B.

FIG. 3A is a back view of two battery racks physically connected in series.

FIG. 3B is a detail view of the back connection between the two battery racks of FIG. 2A.

FIG. 3C is a detail isometric view of the connection depicted in FIG. 2B.

FIG. 4 is an isometric view of the two battery racks of FIG. 2A.

FIG. 5A is an isometric view of one empty battery rack.

FIG. 5 B is a reversed isometric view of one side wall of the empty battery rack of FIG. 5A.

FIG. 6 is a process flow for preparing an energy storage node of FIGS. 1A and 1B.

Parts Listing

| | |
|---|---|
| 100 | Energy Storage System |
| 104 | Power Conversion Element |
| 105 | Central Control System Element |
| 110A-N | Energy Storage Nodes |
| 111 | Energy Storage Element |
| 113 | External Grid |
| 201A-B | Battery Rack |
| 202A-P | Battery Module |
| 203A-B | Battery Module Control System |
| 204A-B | Battery String |
| 205 | Front Connector Plate |
| 302A-P | Rack Slot |
| 303A-B | Control System Slot |
| 305 | Back Connector Plate |
| 310A-L | Back Cross Bar |
| 315A-H | Rear Stopper Bracket |
| 402 | Top Tab Stiffener |
| 510A-H | Side Cross Bar |
| 511A-F | Vertical Cross Bar |
| 512A-E | Lateral Cross Bar |
| 513A-B | Base Support |
| 600 | Method |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

The term “coupled” as used herein refers to any logical, physical, electrical, or optical connection, link or the like by which signals or light produced or supplied by one system element are imparted to another coupled element. Unless described otherwise, coupled elements or devices are not necessarily directly connected to one another and may be separated by intermediate components, elements, or communication media that may modify, manipulate, or carry the light or signals.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately,” “significantly,” or “substantially” means that the parameter value or the like varies up to ±25% from the stated amount.

The orientations of the battery nodes, cores, arrays, racks, elements, modules, submodules, strings, banks, or cells; associated components; circuits; and/or any complete devices, such as battery energy storage systems or modular energy storage systems, incorporating battery nodes, racks, elements, modules, submodules, strings, banks, or cells such as shown in any of the drawings, are given by way of example only, for illustration and discussion purposes. In operation for a particular battery energy storage application, a battery node, core, array, rack, element, module, submodule, string, bank, or cell may be oriented in any other direction suitable to the particular application of the battery energy storage system, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system or battery nodes, racks, elements, modules, submodules, strings, banks, or cells; or component of an energy storage system or battery node, rack, element, module, submodule, string, bank, or cell examples illustrated in the accompanying drawings and discussed below.

Unless otherwise indicated, any multiplicity of components, such as energy storage nodes, battery strings, or battery modules can include any number of said components, including as few as one, and are not limited by the depicted number of components. Unless otherwise indicated, any coupled electrical components can be linked in series or in parallel. In the case of energy storage nodes or battery modules, the component may be linked in both series and/or in parallel, depending upon the state of the switch or submodule.

Reference now is made in detail to the examples illustrated in detail to the examples illustrated in the accompanying drawings and discussed below.

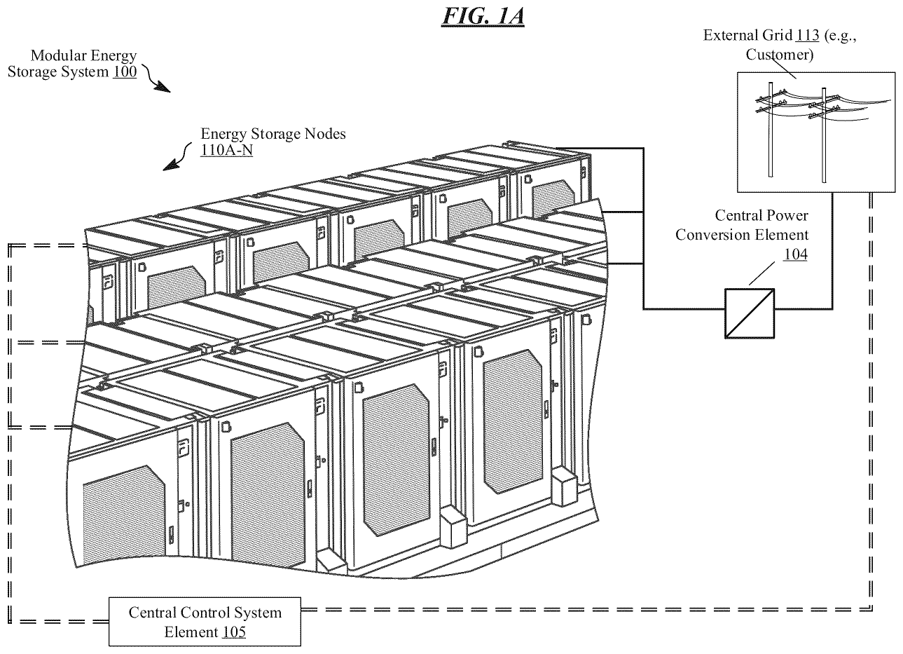

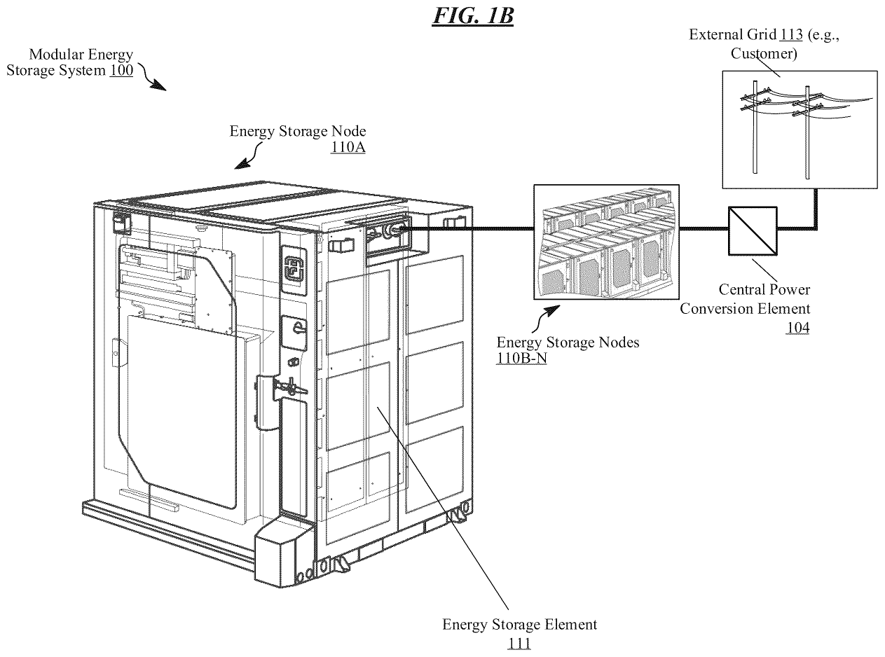

FIG. 1A is an isometric view of a modular energy storage system 100 that includes multiple energy storage nodes 110A-N, a central control system element 105, and an external grid 113. The modular energy storage system 100 includes multiple energy storage nodes 110A-N optionally connected to a central power conversion element 104. For example, the energy storage nodes 110A-N include batteries of any existing or future reusable battery technology that can be used in a battery energy storage system (BESS), including, but not limited to, lithium ion or flow batteries, or mechanical storage, such as flywheel energy storage, compressed air energy storage, pumped-storage hydroelectricity, gravitational potential energy, or a hydraulic accumulator. The energy storage nodes 110A-N, collectively and individually, are capable of providing direct current electricity to an external load, and thereby discharging, as well as are capable of receiving direct current electricity from an external source, and thereby charging.

To facilitate providing and receiving direct current, the energy storage nodes 110A-N can be connected to the central power conversion element 104. The central power conversion element 104 is configured to standardize power inputs and outputs to and from the energy storage nodes 110A-N. The central power conversion element 104 can be comprised of: (1) an inverter, converting the DC source of the energy storage nodes 110A-N to an AC waveform, and vice versa; (2) a DC/DC converter, converting the DC source of the energy storage nodes 110A-N to a different DC source characteristic; (3) other known power conversion elements; or (4) a combination thereof.

When the energy storage nodes 110A-N provide direct current, the central power conversion element 104 transforms direct current into alternating current for use by the external grid 113 and normalizes the amperage from the battery modules 110A-N to the external grid 113. Additionally, when the energy storage nodes 110A-N require direct current, the central power conversion element 104 transforms alternating current into direct current from the external grid 113 and normalizes the amperage from the external grid 113 to the energy storage nodes 110A-N. The power conversion element 104 can also be implemented in a distributed manner, where the energy storage nodes 110A-N are each coupled to a distributed power conversion element, which may perform some or all of the tasks of a central power conversion element 104, and may obviate entirely the use of a central power conversion element 104.

The modular energy storage system 100 including the energy storage nodes 110A-N and the central power conversion element 104 is depicted with a single connection to the external grid 113: in scenarios where the external grid 113 is complex and connects to multiple energy sources and connected loads, such as a power grid with consumption devices, a single connection to the modular energy storage system 100 can either absorb energy produced by the energy sources of the external grid 113 in excess of the demand of the connected loads of the external grid 113, or provide energy to the connected loads of the external grid 113 in excess of the capacity of the energy sources of the external grid 113. Alternatively, separate lines may run to a segregated energy source as well as to connected loads or the external grid 113: separate lines may be advantageous in scenarios where the segregated energy source is inconsistent, such as a wind or solar-based energy source. In such scenarios, the power from the energy source is pushed to the energy storage modules 110A-N, which then either charge or discharge, and provide consistent energy to the connected loads or external grid 113 via another electrical route.

An energy source can be any suitable system for producing electrical energy, such as a turbine or photovoltaic cell. The external grid 113 can include a power grid or a smaller local load such as a backup power system for a facility such as a hospital, manufacturing site, residential home, or other suitable facility.

The central power conversion element 104 can facilitate normalizing input or output wattage or voltage, in order to provide consistent output and protect the energy storage nodes 110A-N or external grid 113 from damage. The central power conversion element 104 may perform this normalization in concert with a central control system element 105. The central control system element 105 also communicates with and controls the energy storage nodes 110A-N in order to adjust electrical output, as well as electrical capacity or intake of the energy storage nodes 110A-N. The central control system element 105 can have components which operate completely independently at an energy storage node 110A level. Therefore, the central control system element 105 can be configured to operate in a combination of independent and centralized operation.

Generally, the energy storage nodes 110A-N of the modular energy storage system 100 connected to the external grid 113 operate in concert: either providing power to the external grid 113 and discharging, or receiving power from the external grid 113 and charging. This concerted effort is coordinated by central control system element 105, and other control units such as market dispatch units or real-time automation controllers, not depicted here. Further methods and systems related to the management and maintenance of the energy storage nodes 110A-N (e.g., battery modules 110A-N) of the modular energy storage system 100 (e.g., battery energy storage system 100) are disclosed in U.S. application Ser. No. 17/810,983, filed on Jul. 6, 2022, now U.S. Pat. No. 11,789,086, issued Oct. 17, 2023, titled “Cell and Rack Performance Monitoring System and Method,” the entirety of which is incorporated by reference herein.

FIG. 1B is an isometric view of an energy storage node 110A, multiple optional energy storage nodes 110B-N, and an external grid 113. The energy storage node 110A includes an energy storage element 111.

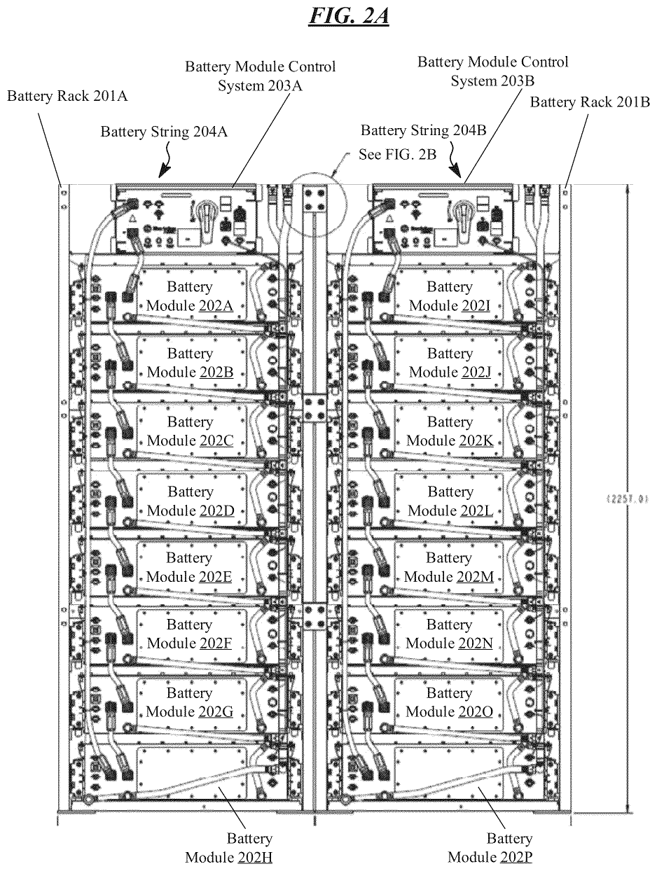

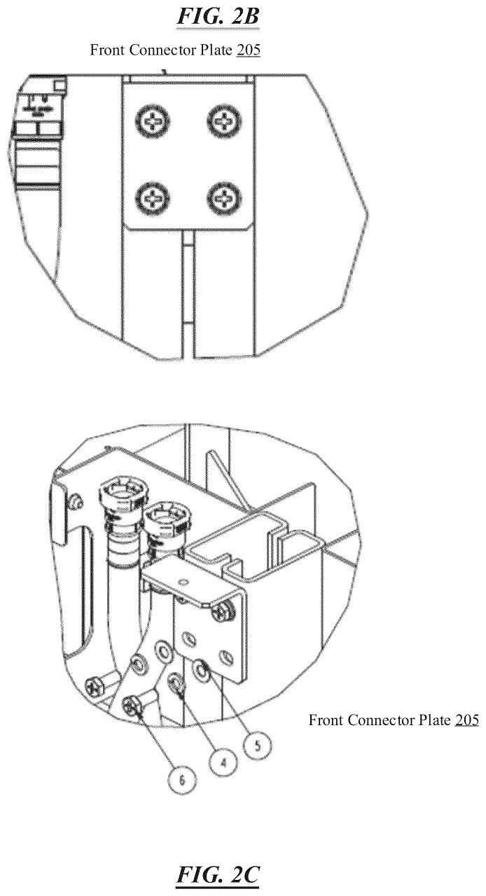

As illustrated in FIG. 2A, the energy storage element 111 includes two battery racks 201A-B, each including a battery string 204A-B. Each battery string 204A-B includes, for example, eight battery modules 202A-H, 202I-P in series. However, the energy storage node 110A can include any number of battery racks, and battery modules. The dimensions of the battery racks and battery modules can be adjusted such that any number of battery modules can fit within any number of battery racks.

FIG. 2A is a front view of two battery racks 201A-B physically connected in physical series, each battery rack 201A-B including eight battery modules 202A-H, 202I-P connected in electrical series. Each battery rack 201A-B can be shipped fully loaded with battery modules 202A-H, 2021-P via sea transport and road transport. Via either form of transportation, the battery rack 201A-B loaded with battery modules 202A-H, 2021-P can handle both the static acceleration and random vibrations of transport, and can meet or exceed the American Society for Testing and Materials (ASTM) D4169-16, “Standard Practice for Performance Testing of Shipping Containers and Systems” at the highest level of assurance.

The battery racks 201A-B are mounted as pairs within an energy storage node 110A. Then, the battery modules 202A-P are installed in the battery racks 201A-B. Up to three energy storage nodes 110A can be placed in a single CONEX-style shipping container. Once arriving at the site, due to the fact that the battery modules 202A-P are already physically within the battery racks 201A-B, in some circumstances the battery modules 202A-H, 202I-P need to be hooked up in series, and with a battery module control system 203A-B (which perform similar functions to the central control system 105), to form battery strings 204A-B, which would be functional for provisioning electrical load.

FIG. 2B is a detail view of the front connection between the two battery racks 201A-B of FIG. 2A. In particular, a front connector plate 205 is shown, connecting the top right corner of one battery rack 201A to the top left corner of the other battery rack 201B. Any number of battery racks 201A-B can be connected via front connector plates 205, however in the current implementation the energy storage node 110A is configured to contain two battery racks 201A-B, and so only one front connector plate 205 connecting two battery racks 201A-B is depicted.

FIG. 2C is a detail isometric view of the connection depicted in FIG. 2B. The front connector plate 205 is shown again, and a hollow tube forming the vertical bars 511A-F (See FIG. 5A) is shown. The front connection plate 205 is secured to the vertical bars using, for example, hardware components such as bolts, screws, washers, etc. denoted as elements 4/5/6 in the drawings.

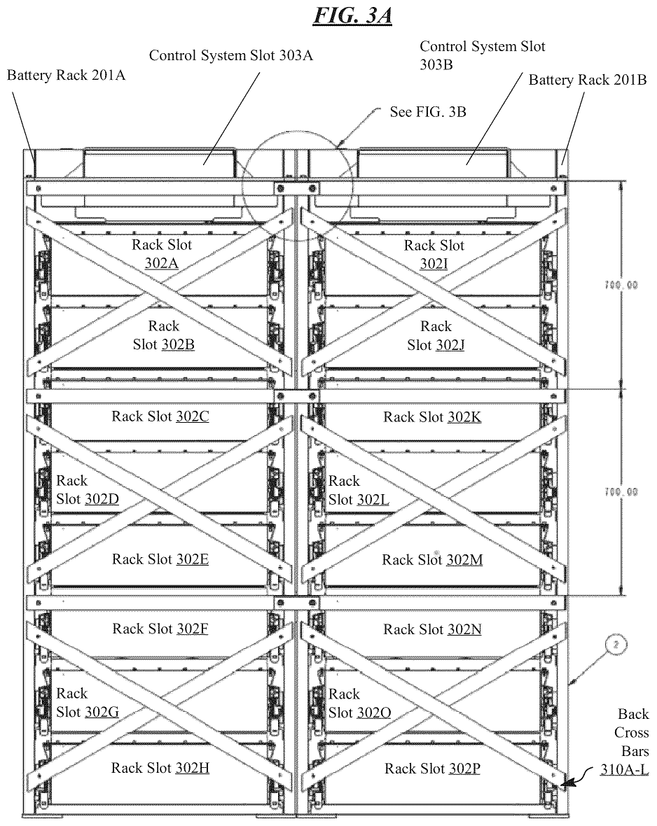

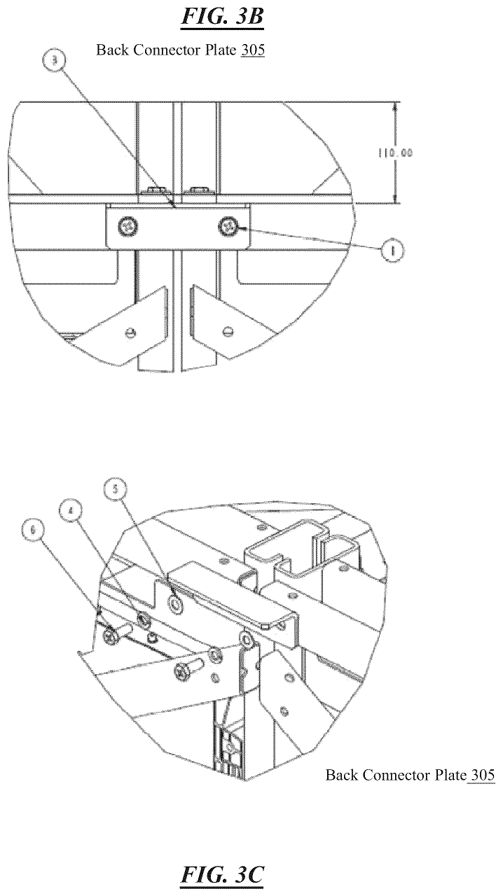

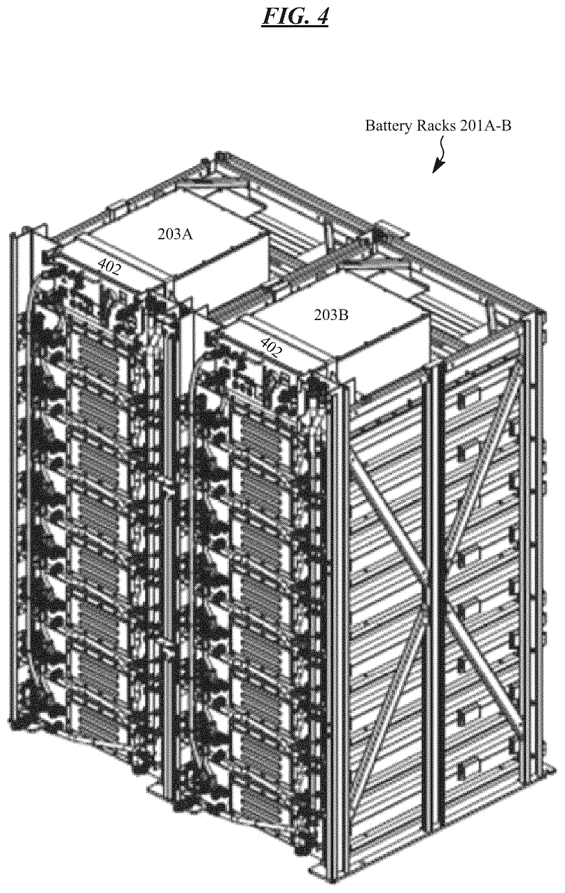

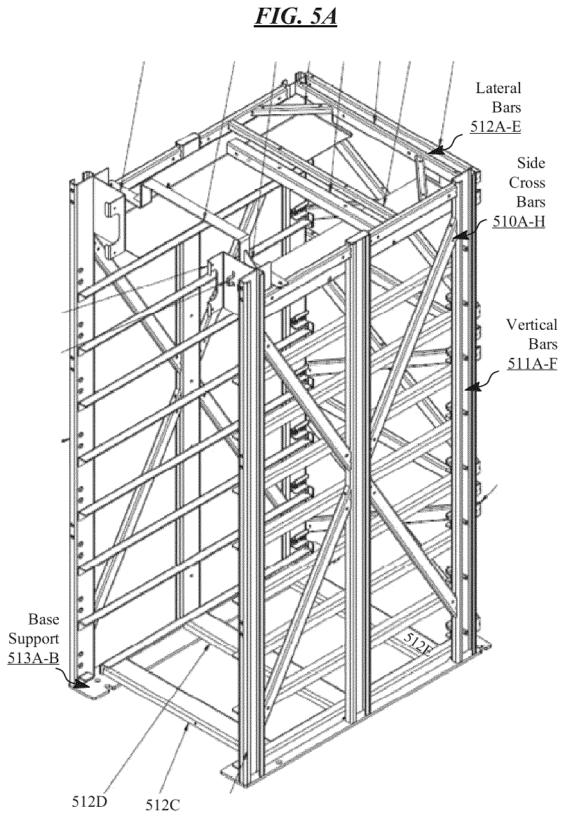

FIG. 3A is a back view of two battery racks 201A-B physically connected in series. The rack slots 302A-P are open, as the battery modules 202A-P are not installed in this depiction of battery racks 201A-B. The back cross bars 310A-L are shown bracing for lateral force across the battery racks 201A-B.

The battery modules 202A-P in this example weigh approximately seven-hundred and seventy-two pounds each, and therefore each battery rack 201A-B must consider a bowing outward force, which in particular can affect the alignment of the modules 202A-P when bolting the battery racks 201A-B into the energy storage node 110A, and when bolting the energy storage node 110A to the ground or other structure. The back cross bars 310A-L reduce the bowing outward force along the width of each battery rack 201A-B. Additionally, the side cross bars 510A-H (see FIGS. 5A-B) reduce the bowing outward force along the depth of each battery rack 201A-B.

The back cross bars 310A-L also maintain side-to-side spacing at the rear of each battery rack 201A-B to restrict sideways motion during seismic events (“High” seismic activity according to the Institute of Electrical and Electronics Engineers (IEEE) 693 “IEEE Recommended Practice for Seismic Design of Substations”) in order to avoid damage to the battery rack 201A-B and avoid damage to the battery modules 202A-P.

FIG. 3B is a detail view of the back connection between the two battery racks of FIG. 2A. In particular, a back connector plate 305 is shown, connecting the top right corner of one battery rack 201B to the top left corner of the other battery rack 201A. Any number of battery racks 201A-B can be connected via back connector plates 305, however in the current implementation the energy storage node 110A is configured to contain two battery racks 201A-B, and so only one back connector plate 305 connecting two battery racks 201A-B is depicted. The back connector plate 305 may be secured to the battery racks 201A-B using, for example, hardware components such as bolts, screws, washers, etc. denoted as 1 and 3-6 in the drawings.

The back connector plates 305, alone or in combination with the front connector plates 205, connect the battery racks 201A-B together, transferring force experienced by one set of back cross bars 310A-F to the other set of back cross bars 310G-L. Consequently, the back connector plates 305 further improve the collective resistance of the battery racks 201A-B to lateral force, in particular when mounted within an energy storage node 110A.

FIG. 3C is a detail isometric view of the connection depicted in FIG. 3B. The back connector plate 305 is shown again, and the hollow tube of the vertical bars 511A-F (See FIG. 5A) are shown.

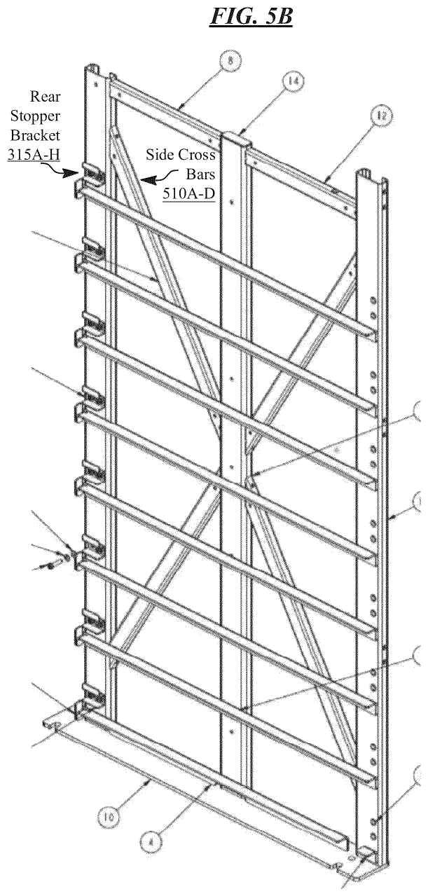

FIG. 4 is an isometric view of the two battery racks 201A-B of FIG. 2A. The battery modules 202A-P can be seen to almost completely fill the depth of the battery racks 201A-B. The tight dimensional tolerances between the battery racks 201A-B and the battery modules 202A-P without the gaps between the side cross bars 510A-H, vertical bars 511A-F, (see FIG. 5A and back cross bars 310A-L, could cause issues with trapping gas in scenarios where the battery modules 202A-P release gas. However, the gaps in the battery racks 201A-B allow for gas to escape the structure, and be vented out by the energy storage node 110A.

FIG. 5A is an isometric view of one empty battery rack 201A. The battery rack 201A includes lateral bars 512A-B across the top and lateral bars across the bottom 512C-E. Side cross bars 510A-H support the battery rack structure 510A-H against the normal force experienced by the battery rack 201A as well as the battery modules 202A-H. The side cross bars 510A-H serve a similar purpose to the back cross bars 310A-L, except the side cross bars 510A-H primarily reduce torsion and bowing outward deflection along the depth of the battery rack 201A. A top tab stiffener 402 (FIG. 4) is connected between at least one of the top lateral bars 512A-B and the battery module control system 203B of the corresponding battery string 204A-B of the battery racks 201A-B.

The battery rack 201A-B has a skeletal design, with back cross bars 310A-L and side cross bars 510A-H, rather than full sheet steel walls. The skeletal design does not obstruct a gas path if the battery modules 202A-P experience off gassing. As the battery racks 201A-B are often mounted within an energy storage node 110A (FIG. 1A), the walls and top of the energy storage node 110A protect the battery modules 202A-P from the environment, and a second set of walls performing the same role would be extraneous. Similarly, the battery rack 201A-B does not include closed tubes or enclosed areas in the structure, in order to avoid gas trapping. The side cross bars 510 A-H and vertical bars 511A-F are all hollow tubes with open channels, or are two-dimensional sheets or bent sheets of metal. The skeletal design is lighter than full sheet steel walls, while ultimately supporting more mass.

The skeletal design also allows for easier installation of the battery rack 201A-B within the energy storage node 110A. The base supports 513A-B of a battery rack 201A has several bolt holes, which sit outside the footprint of the battery modules 202A-H at both the front and the back of each base support 513A-B.

FIG. 5B is a reversed isometric view of one side wall of the empty battery rack of FIG. 5A. This view shows with greater clarity the bolt connection points within the base support 513A: a bolt hole and a bolt slot at the front of the base support 513A, and another bolt hole and bolt slot at the back of the base support 513A. Bolts driven through these holes and slots can connect to the energy storage node 110A, the ground or slab upon which the energy storage node 110A sits, or a combination thereof. Bolts can also be temporarily attached to a pallet or a CONEX-style shipping container during transit.

Components such as plates, tables, or the rear stopper brackets 315A-H, in particular at the back of the battery rack 201A, position the battery modules 202A-H upon installation in such a way that the max allowable movement is less than or equal to 2 millimeters sideways.

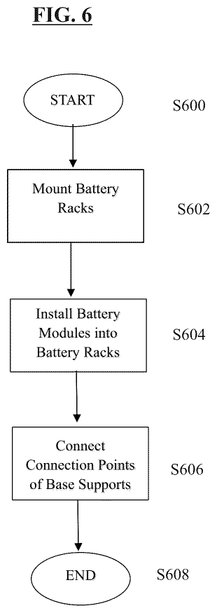

FIG. 6 describes a process flow for preparing an energy storage node 110A-N in FIGS. 1A and 1B. The process begins at step S600 and moves to step S602. At S602, preparing the energy storage node 110A generally first involves mounting battery racks 201A-B into the energy storage node 110A. Then, at step S604, the battery modules 202A-P are installed into the battery racks 201A-B. The skeletal design allows for access by a technician to be able to install, at step S606, connecting bolts between the battery racks 201A-B and the energy storage node 110A—the technician enters the battery rack 201A, reaches between the back cross bars 310A-L, and inserts and tightens a set of bolts into the back of the base supports 513A-B (FIG. 5A). However, in designs where a battery rack has full sheet steel walls, the technician either has to partially disassemble the battery rack, partially disassemble the energy storage node 110A, or have an extremely long bolt driver to reach the entire height of the battery rack, in order to install the rear bolts, which would be installed in the narrow gap between the full sheet steel back wall and the wall of the energy storage node 110A—a gap which may be as small as a quarter inch. At step S608, the process is complete when the energy storage node is secured and/or placed in a shipping container.

The energy storage node 110A stores the plurality of battery strings as a battery bank and as an energy storage element 111. The energy storage node 110A is both a physical housing of energy storage element 111, as well as a logical and electrical collection of the battery bank that constitutes energy storage element 111: the energy storage node 110A physically houses the battery bank, and the electrical performance of the battery bank comprising the energy storage element 111 may be attributed to the energy storage node 110A itself. For example, if a battery string of the battery bank is able to store ninety-six kilowatt hours of energy, and the battery bank contains two battery strings, then the energy storage node 110A (as well as the energy storage element 111) may be understood to and be described as storing one hundred and ninety-two kilowatt hours of energy.

In the exemplary embodiment of FIG. 2A, a given battery string 204A contains multiple battery modules 202A-H. Much like the relationship between the energy storage node 110A and contained battery bank, the battery string 204A-B is both a physical collection of battery modules 202A-P as well as a logical and electrical collection of battery modules 202A-P. As an example, if a battery module 202A is able to store twelve kilowatt hours of energy, and the battery string 204A contains eight battery modules 202A-H, then the battery string 204A may be understood to and be described as storing ninety-six kilowatt hours of energy.

As the battery string 204A-B is a logical and electrical collection of battery modules 202A-P, the collection is not necessarily defined by the physical structure or ordering of the battery modules 202A-P. In this example, however, the constituent battery modules 202A-H, 2021-P in this example are wired in series. Therefore, the battery string 204A-B may be alternatively described as a battery rack 201A-B, a battery sub-rack, or a battery array: each of these terms (rack, sub-rack, array) can be categories of battery string 204A-B: a battery string 204A-B is the logical and electrical collection of battery modules 202A-P, without explicit regard for physical structure or ordering of the battery modules 202A-P, other than in this particular example wiring in series. In some implementations, a finer level of encapsulation exists within the battery module 202A-P, which may be identified as a battery grouping within the battery module 202A-P. Those battery groupings may also include a finer level of encapsulation, which may be identified as a battery cell within the battery grouping, comprising prismatic, pouch, or cylindrical battery cells.

In this example, the energy storage node 110A represents a single physical fixture, which may be limited in maximum size by the mass or volume a person, forklift, or vehicle is capable of transporting as a singular, atomic unit. The battery bank within the battery module 110A represents a physical organizational structure for organizing and wiring battery cells, groupings, battery modules 202A-P, and battery strings 204A-B within the energy storage node 110A. A battery cell is generally the largest unit of manufacture a battery producer can produce capable of charging and discharging electricity at a chemical level. Battery cells may be packaged together as battery modules 202A-P, representing the smallest unit a particular operator would remove or replace in the modular energy storage system 100. In embodiments in which multiple battery cells are packaged together, the individual battery cells may be too small or sensitive to perform on-site particularized maintenance. As such, the entire package of battery cells (e.g., a battery module 202A) is either collectively repaired or replaced.

The energy storage nodes 110A may resemble the features presented in the energy storage system described in International Application No. PCT/US2021/030551, filed on May 4, 2021, titled “Energy Storage System with Removable, Adjustable, and Lightweight Plenums,” (published as WO 2021226011 on Nov. 11, 2021) the entirety of which is incorporated by reference herein.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. An energy storage node, comprising:
a plurality of battery racks, each of the battery racks including a plurality of rack slots configured within the energy storage node to support a battery string of a plurality of battery strings,
wherein each of the battery racks further includes:
at least one pair of back cross bars arranged at a rear of the rack slots to reduce a bowing outward force along a width of each of the battery racks,
at least one pair of side cross bars arranged at a side wall of each of the battery racks to reduce a bowing outward force along a depth of each of the battery racks,
a plurality of hollow vertical bars,
at least one front connector plate arranged at a front of the battery racks to connect at least two of the plurality of hollow vertical bars, and
at least one back connector plate arranged at rear of the battery racks to connect the plurality of battery racks to a rear set of the pair of back cross bars.

2. The energy storage node of claim 1, wherein:
the battery string includes a plurality of battery modules electrically connected in series, in parallel, or a combination thereof; and
each of the battery modules includes at least one battery storage element.

3. The energy storage node of claim 2, wherein each battery string includes at least eight battery modules connected in series within the energy storage node.

4. The energy storage node of claim 1, wherein the plurality of battery racks are mounted as pairs within the energy storage node.

5. The energy storage node of claim 1, wherein each of the battery racks further comprises a plurality of lateral bars arranged at a top and bottom of a corresponding battery rack.

6. The energy storage node of claim 5, wherein an outermost area of each of the battery racks is solely provided by the back cross bars, the side cross bars, and the lateral bars.

7. The energy storage node of claim 5, wherein each of the battery racks further comprises a top tab stiffener connected between at least one of the top lateral bars and a module controller of a corresponding battery string of the battery racks.

8. The energy storage node of claim 1, wherein the each rack slot in each of the plurality of battery racks comprises a rear stopper bracket arranged at a rear of the rack slot and adjacent a corresponding side wall of each of the battery racks.

9. An energy storage system comprising a plurality of energy storage nodes of claim 1.

10. A method of handling transportation force loads, comprising:
preparing an energy storage node, wherein the preparing includes:
a plurality of battery racks, each of the battery racks including a plurality of rack slots configured within the energy storage node to support a battery string of a plurality of battery strings,
wherein each of the battery racks further includes:
at least one pair of back cross bars arranged at a rear of the rack slots to reduce a bowing outward force along a width of each of the battery racks,
at least one pair of side cross bars arranged at a side wall of each of the battery racks to reduce a bowing outward force along a depth of each of the battery racks,
a plurality of hollow vertical bars,
at least one front connector plate arranged at a front of the battery racks to connect at least two of the plurality of hollow vertical bars, and
at least one back connector plate arranged at rear of the battery racks to connect the plurality of battery racks to a rear set of the pair of back cross bars;
mounting the plurality of battery racks within the energy storage node;
installing a plurality of battery modules into the plurality of battery racks; and
connecting the plurality of battery racks within the energy storage node using at least one base support having a plurality of connection points and arranged between the battery racks and the energy storage node.

11. The method of claim 10, wherein the plurality of battery racks are mounted as pairs within the energy storage node.

12. The method of claim 10, the preparing the energy storage node further comprises:
the battery string including a plurality of battery modules electrically connected in series, in parallel, or a combination thereof; and
each of the battery modules including at least one battery storage element.

13. The method of claim 12, the preparing the energy storage node further comprises each battery string of the energy storage node including at least eight battery modules connected in series within the energy storage node.

14. The method of claim 10, wherein preparing the energy storage node further comprises forming each of the battery racks to comprise a plurality of lateral bars arranged at a top and bottom of a corresponding battery rack.

15. The method of claim 14, wherein an outermost area of each of the battery racks is solely provided by the back cross bars, the side cross bars and the lateral bars.

16. The method of claim 14, wherein preparing the energy storage node further comprises forming each of the battery racks to include a top tab stiffener connected between at least one of the top lateral bars and a module controller of a corresponding battery string of the battery rack.

17. The method of claim 14, wherein preparing the energy storage node further comprises, for the each rack slot of the plurality of battery racks, arranging a rear stopper bracket at a rear of the rack slot and adjacent a corresponding side wall of each of the battery racks.
